(19) United States
(12) Patent Application Publication
(10) Pub. No.: US 2007/0276750 A1
(43) Pub. Date: Nov. 29, 2007

(54) Method and system for credit status calculation, monitoring, and maintenance

(76) Inventor: Robert Stuart, Houston, TX (US)

Correspondence Address: Hugh R. Kress;Browning Bushman P.C., Suite 1800, 5718 Westheimer, Houston, TX, 77057, US

(21) Appl. No.: 11/451,214

(22) Filed: Jun. 12, 2006

Related U.S. Application Data
(60) Provisional application No. 60/689,734, filed on Jun. 10, 2005.

(51) Int. Cl. G06Q 40/00

(52) U.S. Cl. 705/38

(57) ABSTRACT

A credit monitoring and maintenance system including various computer-based processes. In one embodiment, the system includes processes for accepting inputs including one or more credit report values specific to a borrower generated by one or more credit reporting bureaus, and for further accepting additional inputs from other sources comprising data specific to the borrower and not utilized by the credit reporting bureaus in the computation of the credit report values for the borrower. The system further preferably includes processes for generating custom credit reports including custom credit rating values based upon the credit report values and the additional inputs. The system also further preferably includes processes for generating one or more credit management prompts computed to lead to improvements in the credit report values generated by the one or more credit reporting bureaus, to the extent that the borrower takes actions commensurate with the credit management prompts.

### CROSS-REFERENCE TO RELATED APPLICATIONS

This application claims the priority of prior U.S. Provisional application Ser. No. 60/689,734 filed on Jun. 10, 2005, which application is hereby incorporated by reference herein in its entirety.

### FIELD OF THE INVENTION

The present invention relates to the advancement of credit by lenders to borrowers, and more particularly relates to the rating of a borrower's credit-worthiness and the proactive management of a borrower's credit status.

### BACKGROUND OF THE INVENTION

Seventy-five percent of the populace (individuals 18 years old or older) is eligible for credit in the United States. Each month, 4.5 billion pieces of credit information are entered into individual credit records, with more than one billion credit reports issued each year by the national credit reporting agencies. Those of ordinary skill in the art will appreciate that a select few of these agencies dominate the credit industry, notably Experian, Costa Mesa, California, TransUnion LLC, Chester, Pa., and Equifax, Inc., Atlanta, Ga.

There are over 200 million individual credit accounts in the USA: (i) 150 million credit card holders, averaging 10 cards apiece, and more than $2.0 trillion in unsecured debt; (ii) $8.0 trillion in home mortgages; and, (iii) $1.3 trillion in installment debt.

The most widely used credit score, called “FICO,” arose out of a joint venture between Equifax and Fair Isaac Corporation in 1989. Fair Isaac provides financial services to the largest banks in the world, as well as many multi-national companies across the globe.

Fair Isaac is not in the business of maintaining a database of individual credit profiles. Instead, it supplies the software (and the credit rating computation algorithms) that is used by substantially all of the credit reporting bureaus, and most of the lending community. Companies that adopt the proprietary FICO algorithms, and standardized assumptions, may modify those values to fit their customer base.

As would be known to persons of ordinary skill in the art, FICO credit scores range from 300 to 850, with 40.0% of the scoring population falling under 625, and half above the median of 725. Most institutions, in choosing to customize the system to their particular business models and lending philosophies, vary the emphasis on five primary categories of interest, as well as other specific factors based on the particular type of loan being offered. The five primary categories, recognized throughout the industry, are: (1) payment history; (2) outstanding debt; (3) types of credit extended; (4) length of credit history; and (5) number of credit inquiries made.

Most people have little or no knowledge of the essential steps that an individual credit holder can take to change his or her overall financial status, such as unlocking favorable interest rates, and evaluating and controlling the terms and conditions for each and every type of account.

Both market research and focus groups confirm how important credit issues have become to the individual. The average person knows that their credit score can determine whether or not they can afford or qualify for the interest rates, points and fees required for that home or car they are considering.

The use of credit, today, has become a bridge to a better lifestyle, while one is waiting for the next raise or a new job opportunity. Further, there is a huge appetite by the public for content and services, as shown by the current offerings from telephony, PDA, cable, and internet companies, all competing to sell, to a willing public, ring tones, music, videos, alerts, games, and searches.

Yet, working from a typically limited point-of-view of finance, individuals often devise financial (borrowing and payment) strategies that have little or no basis in fact, thereby placing themselves at risk of unnecessarily deflated credit ratings, and other undesirable consequences.

### SUMMARY OF THE INVENTION

In view of the foregoing, the present invention is directed to a system and method of credit management involving a computer program that advantageously eliminates much of the guesswork typically associated with managing a credit portfolio. This system allows an individual credit holder to organize accounts in such a way that no matter whether the individual is at home, on the road, or out of the country, he or she will be able to proactively keep their records straight, their bills current, and their credit score improving in both the short and long term.

The origin of the present invention arises out of recurring credit issues observed among borrowers. Over time, the present inventor came to believe that education and background are of little value when it comes to understanding and using credit. From this beginning, there has been developed a set of tools in accordance with the invention that organizes and manages the use of multiple credit sources for borrowers.

The system and method in accordance with the present invention allow an individual, to have at his or her fingertips a system that would emulate a Fortune 1000 CFO's methods, without the need for a mainframe computer or a staff of hundreds of accountants and financial advisors.

And, in accordance with an important aspect of the invention, these customized tools include a highly reliable formula for tracking monthly statements from lenders and a highly proactive approach to managing outstanding credit and cash flow, thereby lowering rates of interest, eliminating or reducing transaction costs, and late and over-limit fees. This combination of features markedly improves credit ratings, as well as buying power.

In accordance with another aspect of the invention, a novel set of intuitive credit products, targeting the average consumer is provided. One objective of the invention is to help borrowers break free from the stranglehold of usurious credit. The system in accordance with the invention advantageously eliminates the need to comprehend the complex legal provisions typically found in lenders' terms and conditions, whose “full disclosure” typically does not empower the individual, but rather entangles him or her with high rates and low credit scores.

Using the teachings of the present invention, an individual with an undesirably low credit score (e.g., below 650 and sub-prime interest rates of 19.9% to 29.9%) can, in a relatively short period of time (e.g., 12 months or less) raise that score, and lower interest rates to 9.9% to 16.9%. Those on the cusp of the credit “sweet spot” can achieve, in a similarly relatively short period of time (e.g., 6 months or less), a higher rating, thereby getting the lowest rates available on mortgages, and secured and unsecured lines of credit.

In accordance with still another aspect of the invention, it is contemplated that the invention may be advantageously practice and exploited using a subscription-based model, rather than selling the product outright to end users. That is, it is contemplated that the system of the present invention may be advantageously made available to end users via existing service providers, such as Internet search engines and portals, on a subscription basis. All of these players service millions of viewers and subscribers each day, and each in turn is looking for a new paradigm to separate themselves from the herd, all of them currently feeding from the same ad-revenue trough for most of their income.

In one embodiment, a system in accordance with the present invention is capable of actively managing a plurality of accounts, e.g., one hundred (100) accounts or more.

In accordance with one aspect of the invention redundancies and methods of input into the system is achieved, to ensure maximum user-friendliness. In one embodiment, a user needs only to enter five (5) simple statistics to activate each account; month to month, the user has virtual tracking of his or her account. Then once a month, the user enters four (4) items from each monthly statement.

Thereafter, the program's algorithms are activated to create a goal-oriented payment plan. The system offers an optimized path toward lower interest costs, eliminates late and over-limit fees, and boosts credit scores quickly. Much guesswork is eliminated. When payment is due, users need enter only a limited (e.g., four (4) items of data.

In accordance with still another aspect of the invention, by using the credit tools in accordance with the present invention, an individual has a simplified means for achieving improved cash flow and lower credit scores. By providing a means for overseeing and monitoring each and every one of an individual's accounts, the proactive system in accordance with the invention defines individual pre-set goals, initiates a transaction, and then, contemporaneously, displays the results: the cost savings, the elimination of penalties, and an improving credit score, giving one the incentive to change old habits, thereby providing peace of mind, and the opportunity for a better lifestyle.

In accordance with another aspect of the invention, it is contemplated that the system may be offered as a value-added component of various service providers, such as any one of the major search engines and/or Internet portals, resulting in a substantial number of subscribers and associated potential for collection of fees from such subscribers, at low fixed and/or variable costs associated with subscriber management.

Although service providers such as search engines and Internet portals are generally enjoying increasing sales, 80.0% or more of service providers' revenue derives from an ever-increasing share of the overall advertising revenue pool from all media. However, the “cost of sales” required to earn those dollars is unreasonably high, resulting in a great churning sound as those dollars are paid out in large measure to other, third-party, participants.

The present invention provides a new, captive source of revenue, lending itself to an unlimited number of add-ons, such as banking services, including the “float” in a payments program, and other related products, which could result in billions of dollars of new, annual revenue, and an exceptional Earnings Before Depreciation, Interest, Taxes and Amortization (“EBDITA”), both now and in the future.

### BRIEF DESCRIPTION OF THE DRAWINGS

The foregoing and other features and aspects of the present invention will be best appreciated by reference to a detailed description of specific embodiments of the invention, when read in conjunction with the accompanying drawings, wherein:

FIG. 1 is a simplified block diagram of a creditor and credit reporting system in accordance with the prior art;

FIG. 2 is a block diagram of a creditor and credit reporting system in accordance with one embodiment of the invention and incorporating a credit rating calculation, monitoring, and maintenance system; and

FIG. 3 depicts a graphical user interface presented to a user by a credit reporting system in accordance with one embodiment of the invention.

### DETAILED DESCRIPTION OF A SPECIFIC EMBODIMENT OF THE INVENTION

In the disclosure that follows, in the interest of clarity, not all features of actual implementations are described. It will of course be appreciated that in the development of any such actual implementation, as in any such project, numerous engineering and technical decisions must be made to achieve the developers' specific goals and subgoals (e.g., compliance with system and technical constraints), which will vary from one implementation to another. Moreover, attention will necessarily be paid to proper engineering and programming practices for the environment in question. It will be appreciated that such a development effort might be complex and time-consuming, but would nevertheless be a routine undertaking for those of ordinary skill in the relevant fields.

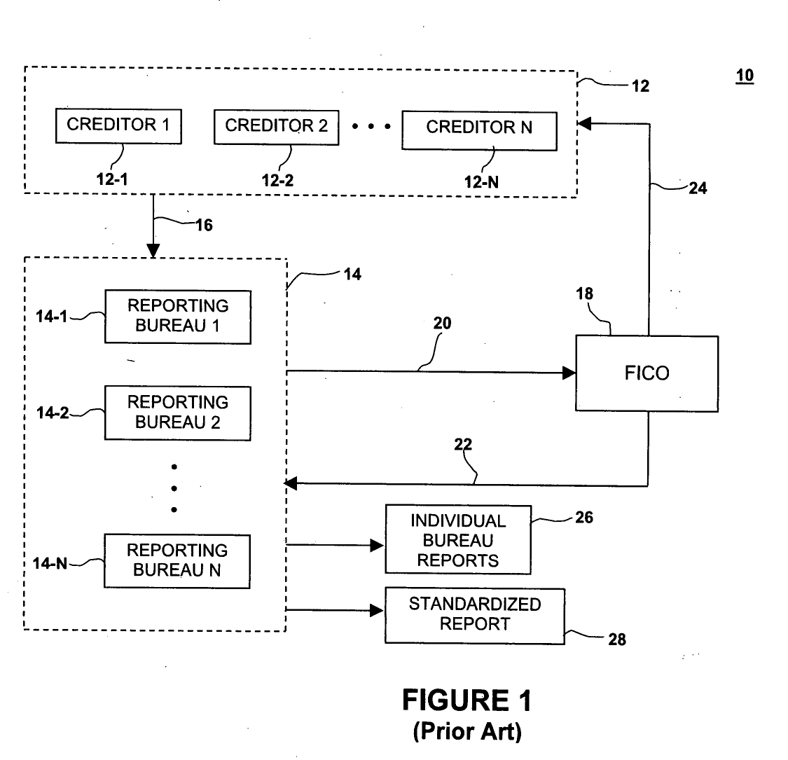

Referring to FIG. 1, there is shown a functional block diagram of a creditor/borrower reporting system 10 that is generally representative of the type of system presently used in the lending industry. As shown in FIG. 1, there are an essentially countless number of creditors in existence who are in the business of extending credit to borrowers under certain circumstances. As used herein, the term “creditors” shall be interpreted broadly, to include such entities as credit card companies, mortgage lenders, automotive financing companies, commercial retailers, banks, and so on, as would be apparent to those of ordinary skill in the art. In FIG. 1, creditors are shown collectively within dashed line designated with reference numeral 12 and shall be referred to collectively as “creditors 12,” with an indeterminate plurality of individual creditors 12-1, 12-2, . . . 12-N being shown in the exemplary embodiment.

With continued reference to FIG. 1, creditors 12 typically report relatively detailed information concerning the nature of credit extended to borrowers to one or more reporting bureaus designated collectively within dashed line 14 and individually with reference numerals 14-1, 14-2, . . . 14-N. As noted above, there are presently a relatively small number of credit reporting entities 14 which predominate in the industry, which is a feature of the state-of-the-art of the credit/lending industry that leads to some potentially undesirable consequences that the present invention is intended to alleviate, as will be hereinafter described in further detail.

The reporting of credit transaction information from creditors 12 to reporting bureaus 14 is represented schematically by arrow 16 in FIG. 1. The transfer of information represented by arrow 16 is relatively detailed, typically including information concerning the individuals to whom credit has been extended, and the detailed terms of the individual credit transactions (amounts, payment terms, interest rates, and so on). It is to be noted and recognized by those of ordinary skill in the art that the transfer of information represented by arrow 16 in FIG. 1 occurs only periodically, for example, once each month, or perhaps even less frequently.

Those of ordinary skill in the art will appreciate that arrow 16 in FIG. 1 is not intended to represent the transfer of credit transaction information from each creditor 12 to each reporting bureau 14. On the contrary, it is more often the case that a given creditor 12 will report to only a subset of the major reporting bureaus 14, perhaps only a single reporting bureau 14. Likewise, it is uncommon if not unheard of for any creditor 12 to report credit transaction information to another creditor 12, nor is it common, at least at present, for individual reporting bureaus 14 to share creditor transaction information among one another.

In accordance with the system 10 currently in place, reporting bureaus 14 report certain statistical information to the well-known credit scoring agency FICO mentioned hereinabove. This reporting to FICO on the part of the reporting bureaus, FICO being identified by reference numeral 18 in FIG. 1, is represented by arrow 20.

It is to be understood and will be appreciated by those of ordinary skill in the art that the reporting represented by arrow 20 in FIG. 1 consists primarily of statistical data, rather than the specific lending/credit transaction data reported by creditors 12 to bureaus 14. Rather, the statistical data reported to FICO 18 consists essentially of information concerning the amount of credit extended to individuals whose credit scores fall within particular ranges. By way of example, a given reporting bureau 14 may report to FICO 18 that the creditors who report to it have extended a certain percentage of their credit to individuals having a credit rating falling below 500, another percentage to individuals having a credit rating between 500 and 650, another percentage to individuals having a credit rating between 650 and 725, and so on. The statistical information provided to FICO 18 may further include information about the types of credit extended, the outstanding debt of the borrowers to whom credit is extended, and so on, as would be understood by persons of ordinary skill in the art.

FICO 18, in turn, utilizes the statistical information provided to it from reporting bureaus 14 (as represented by arrow 20) to establish an algorithm by which an individual's credit rating or credit score can be computed (“the FICO algorithm”). It is to be understood by those of ordinary skill in the art that the algorithm defined by FICO 18 takes into account at least five primary input variables (also known as “scoring weights”), including: (1) payment history; (2) outstanding debt; (3) length of credit history; (4) types of credit; and (5) number of credit inquiries made within a given period of time. The FICO algorithm effectively establishes a weighting system among the various input variables considered and, upon application of the FICO algorithm to the input variables, a credit rating value may be computed. For example, the FICO algorithm may allocate the overall credit score as follows: payment history, 35%; number of credit inquiries, 10%; length of credit history, 15%; types of credit, 10%; and outstanding debt, 30%.

Under the existing system, the FICO algorithm currently generates ratings which fall between a minimum of 300 and a maximum of 850. It is fair to characterize the FICO algorithm as an industry standard for computation of individual credit scores, subject to certain variations that may be introduced as will be hereinafter described. Although ratings between 300 and 850 are described in the illustrative embodiment, it is to be understood that other standards may be used or adopted, and those of ordinary skill in the art will appreciate that the present invention may be advantageously practiced using ratings schemes.

With continued reference to FIG. 1, FICO 18 periodically provides its credit rating algorithm to the reporting bureaus 14, as represented by arrow 22 in FIG. 1, as well as to creditors 12, as represented by arrow 24. Individual credit reporting bureaus 14-1, 14-2 . . . 14-N thereafter use the FICO algorithm as the basis for computing a credit rating or credit score, as represented by block 26 in FIG. 1, for individuals about whom lending transactions are reported by creditors 12. These credit bureau reports are subsequently made available to lenders, among others, in order to provide other lenders with a basis for determining an individual's creditworthiness. However, it is widely recognized that the individual credit bureaus 14 are not bound to adhere strictly to the FICO algorithm in computing an individual's credit score. Instead, individual reporting bureaus 14 can choose to modify the FICO algorithm to place greater or lesser emphasis on various factors (input variables) used to compute a credit score. For example, a credit bureau 14 may decide that the amount of outstanding debt an individual has should be given less weight than is recommended according to the FICO algorithm, or may decide that an individual's payment history is to be given more weight than strict adherence to the FICO algorithm would suggest. Stated differently, individual credit bureaus 14 may, and frequently do, use a customized version of the FICO algorithm.

Likewise, individual creditors 12 can elect to deviate from the algorithm provided to them by FICO (as represented by arrow 24) in determining whether or not to extend credit to a particular individual. For example, and as would be appreciated by those of ordinary skill in the art, certain creditors may determine that it is in the best interest of their particular business model to place more or less weight on the credit-worthiness factors provided as input to the FICO algorithm, or may consider additional factors not taken into account by the FICO algorithm, in determining whether or not to extend credit to a given individual.

The result of this arrangement, and in accordance with a significant aspect of the invention, any given individual's credit score (block 26) may (and often does) vary from one reporting bureau 14 to another. This is due not only to the discretion of each reporting bureau 14 to deviate from the FICO algorithm in one respect or another, but also to the fact that different reporting bureaus 14 receive lending transaction information from different subsets of creditors 12, i.e., not every credit reporting bureau receives information from every creditor, as previously described. Hence, the statistical information provided to FICO as represented by arrow 20 in FIG. 1 will vary from one reporting bureau 14 to another, just as individual credit reports (block 26) will vary from one reporting bureau 14 to another.

It is to be noted that some effort has recently been made on the part of the predominant reporting bureaus 14 to collaboratively generate a uniform credit scoring system to minimize the confusion and uncertainty arising from the possibility of an individual having different credit ratings reported by different reporting bureaus 14. This attempt at standardization is reflected by reference numeral 28 in FIG. 1. However, such standardized reporting has yet to be fully embraced by the lending/credit industry as a whole, and the present invention addresses aspects of credit scoring that are not taken into account even through collaboration between the predominant reporting bureaus 14 may eventually become more prevalent, as will be hereinafter described in further detail.

The system 10 as thus far described suffers from a number of perceived deficiencies that, for the most part, tend to place the borrower at a disadvantage with respect to maintaining an optimal credit rating. Firstly, as described above, not all credit reporting bureaus 14 will typically have access to all of the credit information provided by various lenders relative to a given individual, leading to potential variations between the credit ratings reported by the various credit reporting bureaus. Secondly, there may be a latency between the time a creditor 12 extends credit to a borrower and when the creditor 12 reports the transaction information to one or more credit reporting bureaus 14, such that a given report provided by a reporting bureau 14 may not reflect the most up-to-date information about a given individual. Further, information provided by any given lender generally is incomplete, for example, often excluding the total credit available to a borrower from that lender. Despite the fact that credit limits are not typically considered one of the five “credit scoring” parameters commonly considered, in practical terms, credit limits are often considered closely by potential lenders when deciding whether to extend credit to a borrower.

A further deficiency of the system 10 as thus far described is that the de facto standard FICO algorithm for computation of a credit score is based on only the five nationally recognized scoring weights enumerated above. Thus, a credit score computed in accordance with the FICO algorithm may not take into account various other factors that could have a significant influence on an individual's true creditworthiness.

As a consequence of these and other perceived deficiencies, the present invention seeks to improve upon the existing system in two primary respects: improvement in the credit rating computation methodology to achieve a score that more accurately reflects each individual's true credit worthiness, thereby providing informed and accurate results that may be used with individual creditors; and providing tools for proactively assisting and guiding individuals in making prudent, informed decisions and taking appropriate actions to ensure an optimal credit score.

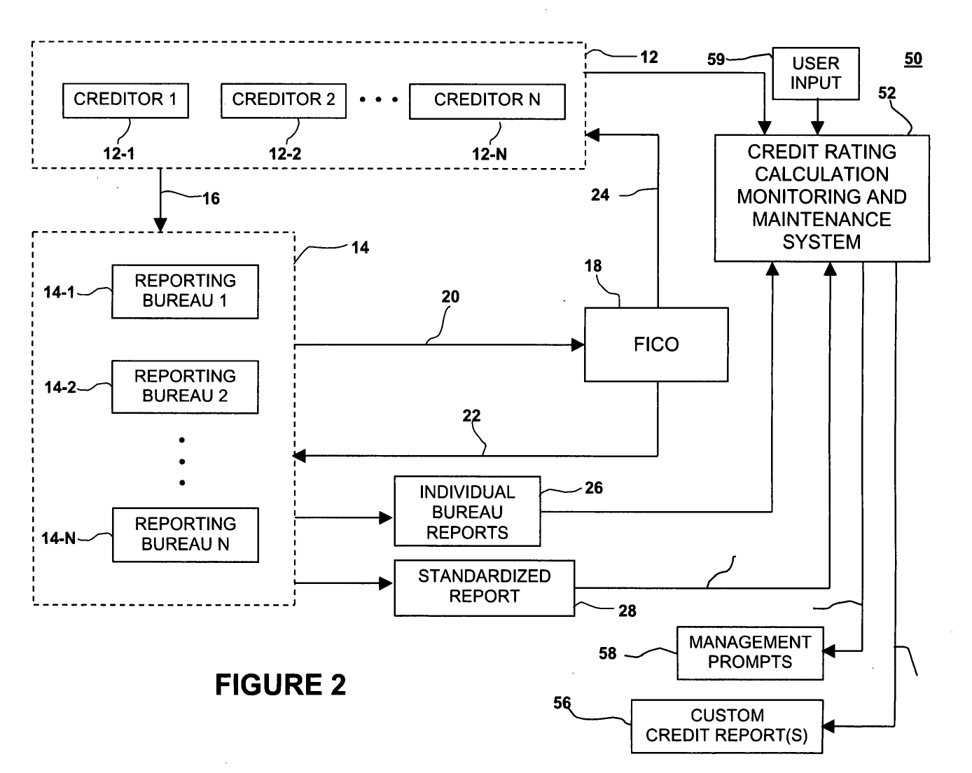

Turning to FIG. 2, there is shown a functional block diagram of a creditor/borrower reporting system 50 in accordance with a presently preferred embodiment of the invention. It is to be understood that those components of system 50 in FIG. 2 that are identical to those previously described with reference to FIG. 1 have retained identical reference numerals in FIG. 2.

A notable feature of system 50 in accordance with the presently disclosed embodiment of the invention is the addition of a credit rating calculation, monitoring and maintenance system, represented by block 52 in FIG. 2. Although represented by a single block 52 in FIG. 2, those of ordinary skill in the art having the benefit of the present disclosure will appreciate that system 52 preferably embodies a plurality of individual functional elements, each preferably implemented in the form of computer processes adapted to perform the functions as described herein.

In accordance with one aspect, the present invention advantageously affords a significant degree of versatility with respect to the implementation of system 52. As will hereinafter become more apparent, system 52 may be implemented in such a manner that it is executed as a stand-alone application for a single user, or alternatively may be implemented to be executed from a central location on behalf of multiple users. Alternatively system 52 may be implemented such that certain processes are executed locally on behalf of a user while other processes are executed at a central location. This flexibility enables the present invention to be commercially exploited in any one of the number of ways including, without limitation, being offered as a service to end-users, or being provided to users as over-the-counter software.

In addition, the versatility of the present invention enables it to be implemented so as to be executed on a variety of different hardware platforms including, without limitation, personal computers, cellular telephones, handheld devices such as personal digital assistants (PDAs), central server platforms accessible by end-users telephonically or by other means, and so on, as would be apparent to persons of ordinary skill in the art having the benefit of this disclosure.

In one embodiment of the invention, system 52 includes the functionality to generate custom credit reports for an end user, as represented by block 56 in FIG. 2. Notably and in accordance with an important aspect of the invention the internal credit scoring mechanism of system 52 preferably takes into account factors other than the limited number of inputs used by the FICO algorithm. For example, system 52, in computing an individual's credit score, may take into account such factors as the users annual income, mortgage indebtedness, including principal and interest installment debt, total unsecured credit, length of credit history, credit bureau reports and ratings, report dates, scores, late payments, write offs, bankruptcy, new credit inquiries within a given period. As a result, the custom credit reports generated by system 52 are far more likely to reflect an individual's true creditworthiness.

In accordance with another aspect of the invention, system 52 further performs a credit management function which, among other benefits, enable system 52 to generate credit management prompts to the user which, if heeded, can lead to significant improvement in a user's credit rating. The generation of credit management prompts is represented by block 58 in FIG. 2.

In a preferred embodiment, system 52 tracks and reports actual progress made by a user before such information is received and reported by the credit bureaus. This helps the user learn and appreciate the benefits of credit management, and improves the timing for purchasing credit reports and credit scores, matching actual changes and relevance. System 52 preferably monitors all aspects of the users monthly statements including past histories, account activity, account balances, and so on. The management prompts 58 can include such information as whether it payment is due, late, or missing, for a given account.

Management prompts 58 further serve to minimize or eliminate the likelihood of late fees, over-limit fees, and unnecessary rate changes due to payment timing and size. Management prompts 58 help to ensure that no statement would be missed by the user no matter if the statement relates to a new account, there was no payment due during the last period, the statement was delivered to the wrong address, misplaced by the user, and so on.

In accordance with another feature of the invention, system 52 preferably proactively calculates aggressive payment behavior with precalculated minimum payments being suggested which may exceed the minimum payments specified by a lender. The payment date for each account is calculated, with a payment schedule being suggested, taking into account whether payments are to be made by mail, telephone, online, and so on, and further taking into account such factors as weekends, holidays and the like.

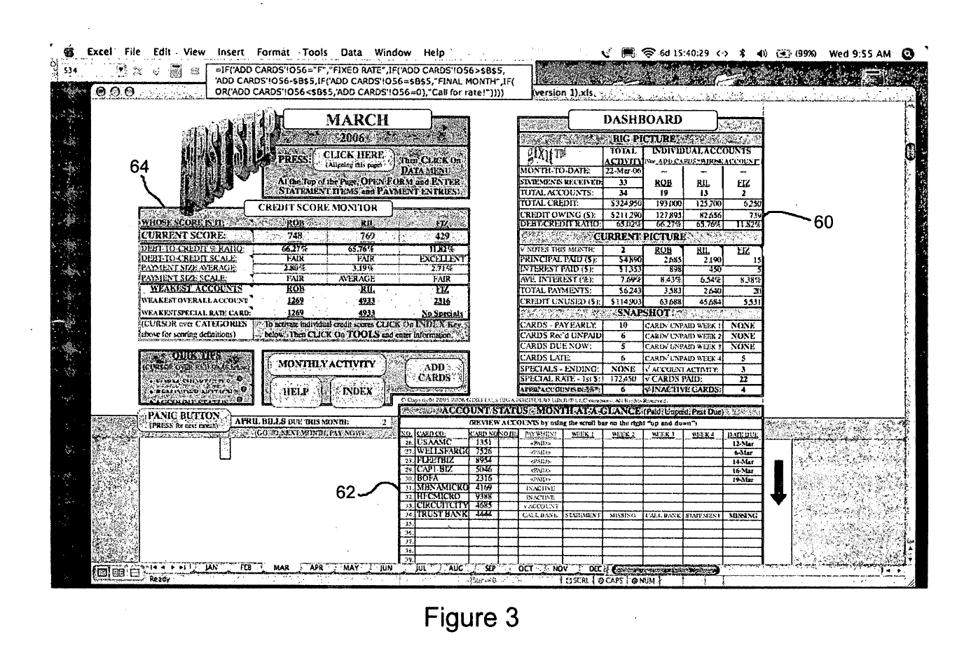

Preferably, a system in accordance with the present invention utilizes a graphical user interface to present credit related information to the user. FIG. 3 is an illustrative example of a user screen including a “dashboard” section providing summary information (account balances, principal and interest paid and due, total credit owing, and so on) to the user (reference numeral 60), an account status section (reference numeral 62) showing paid, unpaid, due, past due, and due dates payment information, and a credit score Monitor section (reference numeral 64) providing custom credit report information.

It is to be understood that the specific arrangement and presentation of information shown in FIG. 3 is merely illustrative of one example of a graphical user interface suitable for this purpose, and is believed that persons of ordinary skill in the art would be readily capable of designing and implementing graphical user interfaces suitable for performing the functions and realizing the benefits of the invention as described herein without undue experimentation.

In addition, it is believed that persons of ordinary skill in the art having the benefit of the present disclosure would be readily capable of developing the formulas and algorithms necessary to guide a user in management of credit in such a way as to track and preferably improve the user's credit rating(s). Particular algorithms used for generating custom credit reports and management prompts as described above in a currently preferred embodiment of the invention are set forth in Appendix A to this disclosure. Again it is to be understood that the invention is not limited to the particular algorithmic approaches defined IN Appendix A, which is provided for illustrative purposes only.

Summarizing, system 52 embodies an internal credit scoring mechanism that tracks actual daily events of the credit user, preempting FICO and other scores, by weeks and months. In one embodiment, this mechanism takes into account: i) the user's personal data, including, without limitation, annual income, mortgage principal and interest, installment debt, unsecured credit, and number of years that user has had credit; and ii) credit bureau(s)' reports and ratings (credit scores), including report dates, scores, late payments, write offs, bankruptcy, and number of inquiries for “new credit” in a given period. In accordance with a significant aspect of the invention, system 52 uses all of this information, over and above the five factors traditionally used in the scoring process by value and mean (average value of a set of numbers).

By preempting FICO, system 52 tracks and reports actual progress made by user, before this information is received and reported by the credit bureaus. This assists the user in learning and appreciating the benefits of credit management, and improves timing for purchasing credit reports and credit scores, matching actual change and relevance and applying for new credit or improved terms on existing credit. This has the almost immediate effect of promoting improvement in a user's credit rating, to the extent that the user takes heed of the management prompts generated by system 52, which are typically more aggressive than minimum activities required by lenders, and which take into account numerous factors and variables not considered in a conventional credit rating scenario. This gives the user an advantage compared with prior art systems.

Furthermore, system 52 generates a custom credit score/report (block 56) for the user, which has been shown using the algorithmic approach of Appendix A to closely track score variations in FICO and others. In addition, system 52 shows the relevance of payment size, and debt-to-credit ratios, and enables users to pay down or pay off weaker accounts in an orderly yet aggressive manner; and in more extreme cases, depending on annual fees and other costs, calculated in time and money, closing the account permanently.

In accordance with another aspect of the invention, system 52 tracks all aspects of the lender's monthly statement. Tools are provided for monitoring past history, account activity, account balances and more to determine statement status, preempting late payments, identifying payments by such categories as: “not due yet,” “late,” “missing,” and “inactive.”

In accordance with yet another aspect of the invention, system 52 eliminates or greatly reduces the likelihood of the user incurring late fees, over-limit fees and rate changes due to payment timing and size, by providing management prompts (block 58) to ensure that no statement will be missed by user, no matter if it is new, no payment is overdue, no statement has been delivered to the wrong address, and so on. System 52 also preferably checks and monitors interest rates and fees, matching statements received by the user to internal auditing information. System 52 preferably also facilitates the tracking of refunds, rate terms and more until they are reconciled by the lender.

As previously noted, the present invention may be implemented in numerous ways, depending upon the particular commercial goals sought to be achieved. In one embodiment the invention may be implemented as a value added service offered by third party providers such as Internet service providers, search engines, “portals,” and the like. In such implementations, system 52 is preferably executed at a central location accessed remotely by the user, for example via a computer, PDA, cell phone, or the like.

In another embodiment, the invention may be embodied in a standalone application made available to users as an “off the shelf” product. In still another embodiment, the invention may be implemented as a service offered by a lending institution, such as a bank or credit card company. Such implementations have the potential additional benefit of enabling the provider of the credit rating calculation monitoring and maintenance system being also capable of providing payment methods to ensure payment fulfillment as an integrated part of the inventive process.

Depending upon the nature of a particular implementation, various hardware platforms may be employed in the practice of the invention. In one embodiment, and end-user may execute an off-the-shelf software application on his or her personal computer, which may be of the notebook, laptop, desktop, tablet, or other type, as would be understood by persons of ordinary skill in the art. Alternatively, the present invention may be implemented in such a fashion that the bulk of the computational functionality is performed by a service provider, such as an Internet service provider, third-party Internet web site, or the like, with informational results being presented to the end-user either on his or her computer, or on some other hardware platform, such as (without limitation) a PDA, handheld computing device, cellular telephone, or other network-capable appliance.

Regardless of the hardware platform involved in a given implementation, the system is preferably capable of communicating to the end-user a compilation of information, such as is shown in FIG. 3, and further provides the end-user with means for interacting with the system, including, for example, a computer display and a mouse or other cursor controlling device, as would be familiar to those of ordinary skill in the art.

It is also to be understood that in any given implementation, there will be an interactive mechanism or process of some sort whereby the end-user provides system 52 with the information necessary to commence and execute the credit monitoring and management processes described herein. This mechanism is schematically represented by block 59 in FIG. 2. Further, it will be apparent to those of ordinary skill that a means by which the end-user can periodically update system 52 with information concerning recent transactions, for example payments made, charges incurred, and other account activity. This would include, of course, providing system 52 with information concerning the user's existing credit accounts and other personal information required to generate the management prompts and custom reports described above. The exact nature of the mechanism(s) 59 by which a user interacts with system 52 to provide such information as described above, and to receive feedback from system 52 in the form of (without limitation) the management prompts and credit reports as described herein is not believed to be critical to the understanding of the invention as disclosed herein. It is believed that those of ordinary skill will readily understand the various means and mechanisms by which a user may be enabled to benefit from the functionality of the present invention as described herein.

The invention as claimed below may be embodied, as noted above, in an “off the shelf” software application distributed to end-users by any of various means (retail sale, download, or otherwise), or in a service provider context in which end-users access one or more remote locations providing the functionality of the invention as described herein. In the latter case, the service provider may further be capable of providing the means by which end-users can consummate various credit related transactions, in which case certain transactions may be automatically registered with the inventive system without the necessity of further user effort.

As noted above, the specific algorithmic approach to generation of the custom credit reports and management prompts as described herein may vary from implementation to implementation, but it is believed that persons of ordinary skill will readily appreciate the general nature of such algorithms so as to be able to track with some degree of consistency the credit rating values generated by various reporting bureaus, FICO, and the like.

Although specific embodiments and design alternatives have been described herein, it is to be understood that this has been done solely to illustrate various aspects of the invention, and is not intended to be limiting with respect to the scope of the invention. It is contemplated that various substitutions, alterations, and/or modifications to the embodiments disclosed herein may be made without departing from the spirit and scope of the invention as defined in the appended claims, which follow.

What is claimed is:

1. A credit monitoring and management system, comprising:
a first process for accepting at least one credit rating value associated with a borrower, said at least one credit rating value being generated by at least one credit reporting bureau;
a second process for accepting additional data pertaining to said borrower's credit status, said additional data including data not considered by said at least one credit reporting bureau;
a third process responsive to said at least one credit rating value and said additional data to generate a custom credit rating value for said borrower.

2. A credit monitoring and management system in accordance with claim 1, further comprising:
a fourth process responsive to said at least one credit rating value and said additional data to generate at least one credit management prompt.

3. A credit monitoring and management system in accordance with claim 2, further comprising:
means for presenting said custom credit rating value to said borrower.

4. A credit monitoring and management system in accordance with claim 3, further comprising:
means for presenting said at least one credit management prompt to said borrower.

5. A credit monitoring and management system in accordance with claim 4, wherein said at least one credit management prompt is calculated to improve said borrower's at least one credit rating value, if acted upon by said borrower.

6. A credit monitoring and management system in accordance with claim 5, wherein said at least one credit management prompt includes a recommended payment amount to a lender of said borrower.

7. A credit monitoring and management system in accordance with claim 6, wherein said at least one credit management prompt includes a recommended payment date for submission of a payment to said lender.

8. A credit monitoring and management system in accordance with claim 1, wherein said additional data includes data concerning said borrower's total credit indebtedness.

9. A credit monitoring and management system in accordance with claim 6, wherein said recommended payment amount is greater than a minimum payment amount specified by said lender.
